(19) United States
(12) Patent Application Publication
(10) Pub. No.: US 2025/0065257 A1
(43) Pub. Date: Feb. 27, 2025

(54) Method and System for Removing Acid Gas from Ethylene Cracking Gas

(71) Applicant: PetroChina Company Limited, Beijing (CN)

(72) Inventors: Yingwen Li, Beijing (CN); Shengbao He, Beijing (CN); Fei Gao, Beijing (CN); Xuesheng Hu, Beijing (CN); Wei Li, Beijing (CN); Taoran Liu, Beijing (CN); Wen Shi, Beijing (CN); Yilong Liu, Beijing (CN)

(21) Appl. No.: 18/724,831

(22) PCT Filed: Dec. 14, 2022
(86) PCT No.: PCT/CN2022/138975

§ 371 Date: Jun. 27, 2024

(30) Foreign Application Priority Data
Dec. 27, 2021 (CN) 202111609522.8
Dec. 27, 2021 (CN) 202111609812.2

(51) Int. Cl. B01D 53/14; B01D 53/18; B01D 53/52; B01D 53/62; B01D 53/78; B01D 53/96

(52) U.S. Cl. CPC B01D 53/1406; B01D 53/1425; B01D 53/1462; B01D 53/1468; B01D 53/1475; B01D 53/18; B01D 53/526; B01D 53/62; B01D 53/78; B01D 53/96; B01D 2252/20405; B01D 2252/20431; B01D 2252/20489; B01D 2252/504; B01D 2252/608; B01D 2257/304; B01D 2257/504; B01D 2258/02

(57) ABSTRACT

A method for removing acid gas from ethylene cracking gas. The method comprises: sequentially subjecting ethylene cracking gas containing acid gas to first-stage supergravity amine scrubbing, second-stage supergravity amine scrubbing, and washing with water, wherein a first-stage compound amine solution is used in the first-stage supergravity amine scrubbing, and a second-stage compound amine solution is used in the second-stage supergravity amine scrubbing. In the present invention, a supergravity technique is used to intensify the amine scrubbing process, and the compound amine solutions are used in cooperation, such that the removal depth of the acid gas is greatly increased, and hydrogen sulfide and carbon dioxide can respectively reach a level of ≤1 μL/L without needing an alkali washing unit.

### FIELD OF THE INVENTION

The present invention relates to the field of gas purification, and specifically relates to a method and system for removing acid gas from ethylene cracking gas.

### BACKGROUND OF THE INVENTION

Ethylene is an important basic organic chemical raw material. The ethylene cracking gas leaving the cracker usually contains some volume of acid gas, mainly hydrogen sulfide and carbon dioxide. Hydrogen sulfide can lead to the poisoning of catalysts used in the subsequent process of cracking gas, as well as the corrosion of equipment and pipelines; carbon dioxide will condense in the subsequent deep-cooling separation process, clogging the pipeline, and it will also continue to be enriched in the circulating ethylene, lowering the partial pressure of the ethylene and leading to the reduction of molecular weight of polymerization products. Therefore, there is a need to remove the acid gas from the ethylene cracking gas before it enters the separation process.

In industry, the acid gas is usually removed from the cracking gas using an alkali scrubbing process or a combined amine-alkali process after three- or four-stage compression, and the content of hydrogen sulfide and carbon dioxide in the cracking gas is strictly controlled to be no more than 1 μL/L. Generally speaking, when the acid gas content is ≤0.1%, it is more economical to use alkali scrubbing process; when the acid gas content is in the range of 0.1% to 0.5%, the use of amine-alkali combined process can reduce the consumption of alkali solution; when the acid gas content is ≥0.5%, it is necessary to desulfurize the raw material. At present, the alkaline scrubbing process is mainly used, usually comprising three stages of alkaline scrubbing and one stage of water scrubbing, or two stages of alkaline scrubbing and one stage of water scrubbing. Large quantities of ethylene waste alkali solution are generated during the alkaline scrubbing process. Ethylene waste alkali solution is a hazardous waste, with strong alkaline; in the process of alkali scrubbing, diolefins condensed or dissolved in alkaline or amine solutions form free radicals under the action of trace oxygen, initiating polymerization; in addition, aldehydes and ketones are susceptible to condensation reactions under the action of alkalis, which likewise result in the formation of polymers of a certain molecular weight, i.e., yellow oil. Yellow oil not only reduces the efficiency of the alkali or amine scrubbing process, it also clogs the alkali/amine scrubbing tower and causes unstable operation of the acid gas removal unit. In the waste alkali solution, a part of organic sulfur such as thioether, mercaptan, etc. is often coated in the yellow oil, which leads to a high toxicity of the waste alkali solution and equipped with a bad odor. Ethylene waste alkali solution is non-renewable and is usually treated using wet oxidation technology, which has high energy consumption, essentially exchanging energy consumption for water quality. With the continuous increase of ethylene production capacity, the source reduction of ethylene waste alkali is also getting more and more attention.

In order to reduce the emission of waste alkali solution and improve the efficiency of the alkali scrubbing tower in removing acid gas, the patent application CN101092576A provides a supergravity alkali scrubbing or amine scrubbing-alkali scrubbing process, but it is still essentially an alkali scrubbing process or a combined amine-alkali process: the use of amine scrubbing is used as a pretreatment means of alkali scrubbing, and part of the acid gas is removed through the amine scrubbing and then enters the alkali scrubbing in order to reduce the consumption of alkali solution. The amine scrubbing process described therein only serves as a pretreatment process for the alkali scrubbing process and does not completely replace the alkali scrubbing process, which still produces ethylene waste alkali solution. In order to minimize the impact of yellow oil generation on the deacidification unit, it is common in the industry to reduce the generation of yellow oil as well as to reduce the risk of yellow oil clogging by the addition of a yellow oil inhibitor. However, yellow oil inhibitors are costly and do not completely avoid the problem of unstable operation of the acid gas removal unit for ethylene cracking gas caused by yellow oil clogging.

### SUMMARY OF THE INVENTION

In order to overcome the problems of insufficient degree of acid gas removal from amine solution, large amount of waste alkali in alkaline scrubbing process, high toxicity, non-renewable and not easy to be disposed of, the present invention provides a method and a system for removing acid gas from ethylene cracking gas, which is specific to a method of removing acid gas from ethylene cracking gas using a Higee amine scrubbing process.

In order to achieve the above objects, the present invention employs the following technical solutions:

On an aspect, the present invention provides a method for removing acid gas from ethylene cracking gas, comprising: subjecting ethylene cracking gas containing acid gas to a first-stage Higee amine scrubbing, a second-stage Higee amine scrubbing and a water scrubbing in sequence;
wherein a first-stage compounded amine solution is used in the first-stage Higee amine scrubbing, and a second-stage compounded amine solution is used in the second-stage Higee amine scrubbing;
the first-stage compounded amine solution and second-stage compounded amine solution independently comprise two or more of triethanolamine, methyldiethanolamine, N-tert-butyl diethanolamine, N-methyl-tert-butylaminoethyloxyethanol, tert-butylaminohexyloxyhexanol, tert-butylaminoethanol, diethanolamine, diglycolamine, methyloethanolamine, N-tert-butylethanolamine and ethanolamine;
wherein at least one tertiary amine is included.

For example, the compounded amine solution is obtained by compounding methyl diethanolamine, N-tert-butyl diethanolamine, and diethanolamine; or by compounding methyl diethanolamine, N-tert-butyl diethanolamine, diethylene glycolamine and N-tert-butyl ethanolamine; or by compounding methyl diethanolamine, methyl ethanolamine and ethanolamine; or by compounding methyl diethanolamine, N-tert-butyl diethanolamine and diethanolamine.

According to the method of the present invention, preferably, each the first-stage compounded amine solution and the second-stage compounded amine solution are regenerated and recycled after absorption of the acid gas.

According to the method of the present invention, preferably, the first-stage compounded amine solution comprises at least one tertiary amine, one secondary amine and one primary amine. More preferably, the molar ratio of the tertiary amine to the secondary amine is 0.1-10:1 and the molar ratio of the secondary amine to the primary amine is 0.5-10:1.

According to the method of the present invention, preferably, the second-stage compounded amine solution comprises at least one tertiary amine, one secondary amine and one primary amine. More preferably, the molar ratio of the tertiary amine to the secondary amine is 0.1-10:1 and the molar ratio of the secondary amine to the primary amine is 0.5-10:1.

Compared to primary and secondary amines, tertiary amines have higher stability, but the absence of hydrogen atoms on their nitrogen atoms prevents them from reacting directly with carbon dioxide, resulting in a lower rate of carbon dioxide absorption. In contrast, primary and secondary amines can react directly with carbon dioxide because of the presence of hydrogen atoms on the nitrogen atom, which can increase the rate of carbon dioxide absorption. Therefore, their use in combination can enhance the rate of carbon dioxide absorption by the amine solution while maintaining a high carbon capacity and improving the efficiency of carbon dioxide removal.

According to the method of the present invention, preferably, the concentration of total amine in each of the first-stage compounded amine solution and/or second-stage compounded amine solution is 5% to 80%; more preferably 15% to 35%. Unless otherwise specified, percentages (concentration, content, etc.) in the present invention are percentages by mass.

In the method of the present invention, the composition and the concentration of total amine of the first-stage compounded amine solution and second-stage compounded amine solution may be the same or different.

According to the method of the present invention, preferably, the first-stage and the second-stage Higee amine scrubbing comprise the following specific processes:
inputting the ethylene cracking gas containing acid gas and the first-stage compounded amine solution to a first-stage Higee reactor through a gas phase inlet and a liquid phase inlet, respectively; after the removal of acid gas by intense contact between the gas phase and the liquid phase inside the stator and rotor, outputting the gas phase and the liquid phase from the gas phase outlet and the liquid phase outlet of the first-stage Higee reactor, respectively, at which the gas phase is sent to the second-stage Higee reactor, and the liquid phase is regenerated and recycled as the first-stage compounded amine solution;
inputting the gas phase from the first-stage Higee reactor and the second-stage compounded amine solution to the second-stage Higee reactor through a gas phase inlet and a liquid phase inlet, respectively; after the removal of the remaining acid gas by intense contact between the gas phase and the liquid phase inside the stator and rotor, outputting the gas phase and the liquid phase from the gas phase outlet and the liquid phase outlet of the second-stage Higee reactor, respectively, at which the gas phase is sent to a water scrubbing unit, and the liquid phase is regenerated and recycled as the second-stage compounded amine solution.

According to the method of the present invention, preferably, the first-stage Higee reactor and/or the second-stage Higee reactor has a rotational speed of 100 rpm to 1400 rpm; more preferably 600 rpm to 800 rpm.

According to the method of the present invention, preferably, the volume ratio of the gas phase to the liquid phase in the first-stage Higee reactor and/or the second-stage Higee reactor is 100 to 500:1, more preferably 100 to 200:1; and the pressure of the gas phase is 0.5 to 2.5 MPa (G), more preferably 0.5 to 2.0 MPa (G).

According to the method of the present invention, preferably, the first-stage Higee reactor and/or the second-stage Higee reactor has a rotational speed of 600 rpm to 800 rpm;

The volume ratio of the gas phase to the liquid phase in the first-stage Higee reactor and/or the second-stage Higee reactor is 100 to 200:1; and the pressure of the gas phase is 0.5 to 2.0 MPa (G).

According to the method of the present invention, preferably, the ethylene cracking gas containing acid gas is derived from a three- or four-stage compressor, wherein the content of hydrogen sulfide is ≤1500 μL/L and the content of carbon dioxide is ≤1500 μL/L, preferably is derived from a three-stage compressor, wherein the content of hydrogen sulfide is ≤1000 μL/L and the content of carbon dioxide is ≤1000 μL/L.

According to the method of the present invention, preferably, the contents of hydrogen sulfide and carbon dioxide in the ethylene cracking gas after the second-stage Higee amine scrubbing are 1 μL/L or less, respectively.

The present invention also provides a method for yellow oil reduction in an acid gas removal unit for ethylene cracking gas, which can be used in the above amine solution recycling process, that is, the process of “inputting the ethylene cracking gas containing acid gas and the first-stage compounded amine solution to a first-stage Higee reactor through a gas phase inlet and a liquid phase inlet, respectively; after the removal of acid gas by intense contact between the gas phase and the liquid phase inside the stator and rotor, outputting the gas phase and the liquid phase from the gas phase outlet and the liquid phase outlet of the first-stage Higee reactor, respectively, at which the gas phase is sent to the second-stage Higee reactor, and the liquid phase is regenerated and recycled as the first-stage compounded amine solution”.

The method for yellow oil reduction in an acid gas removal unit for ethylene cracking gas preferably comprises the following process:
inputting an ethylene cracking gas, a regenerative amine solution and a defoaming agent to a stator-rotor reactor, and the gas phase and the liquid phase leaving the stator-rotor reactor respectively after removal of acid gas by countercurrent contact between the gas phase and the liquid phase inside the stator and rotor;
inputting the liquid phase left the stator-rotor reactor, named rich amine solution, and a scrubbing oil to a Higee reactor for oil scrubbing, after which the rich amine solution and scrubbing oil enter a separation unit for separation;
regenerating the separated rich amine solution into a regenerative amine solution, which enters the stator-rotor reactor for recycling.

Specifically, the ethylene cracking gas enters the reactor through the gas phase inlet of the stator-rotor reactor, the regenerative amine solution enters the reactor through the liquid phase inlet of the stator-rotor reactor, and the defoaming agent enters the reactor through an inlet arranged on the stator. The ethylene cracking gas, regenerative amine solution and defoaming agent are mixed inside the stator and rotor; the liquid phase is sheared and torn into tiny liquid filaments, droplets and films under the action of the two, which has a huge interphase mass-transfer specific surface area and a fast surface renewal rate, and thus can efficiently complete the removal of acid gas from the ethylene cracking gas. After completion of acid gas removal, the gas phase and liquid phase leave the reactor through gas phase outlet and liquid phase outlet of the stator-rotor reactor, respectively. The liquid phase (rich amine solution) and scrubbing oil leaving from the stator-rotor reactor enter the reactor for oil scrubbing through the liquid phase inlet of the Higee reactor. The rich amine solution and scrubbing oil are mixed inside the rotor, and the high-speed rotor crushes the two phases of oil and water into tiny droplets, which are continuously aggregated and dispersed to complete mass transfer process of hydrocarbons from the aqueous phase to the oil phase. The hydrocarbons dissolved in the amine solution are extracted into the scrubbing oil, after which the rich amine solution and the scrubbing oil enter the separation unit for separation; the scrubbing oil agglomerates into an oil phase and leaves from the upper part of the separation unit; the rich amine solution agglomerates into an aqueous phase and leaves from the lower part of the separation unit. According to the yellow oil reduction method the present invention, the liquid phase is driven by the rotor and moves from the inside to the outside, and preferably, the residence time of the gas phase and the liquid phase in the chamber of the stator-rotor reactor is ≤1 s, that is, the residence time of the ethylene cracking gas, the regenerative amine solution and the defoaming agent in the chamber of the stator-rotor reactor is ≤1 s. Because the contact time is 10 very short, it effectively inhibits the mass transfer process of hydrocarbons into the amine solution, which can reduce the dissolution of hydrocarbons and reduce the total amount of yellow oil generated from the source.

According to the yellow oil reduction method the present invention, preferably, the radial distance between the stator ring and the rotor ring of the stator-rotor reactor is 1 mm to 10 mm, preferably 1 mm to 5 mm; and the linear velocity of the outermost rotor is 20 m/s to 40 m/s, preferably 30 m/s to 40 m/s. With a small distance between the stator ring and the rotor ring and a large relative velocity, a strong shear force is generated between the stator ring and the rotor ring, which prevents the generated yellow oil from being deposited on the reactor internal member; for the yellow oil that has already adhered to the internal member, the strong shear force forces it to come off. Therefore, it can greatly enhance the stability of the reactor and ensure the efficiency of acid gas removal.

According to the yellow oil reduction method the present invention, preferably, the defoaming agent enters the reactor through an additive inlet arranged on the stator of the stator-rotor reactor.

The defoaming agent enters the reactor through the additive inlet and then impinges with the amine solution to achieve initial mixing. The presence of impurities in the amine solution can lead to a foaming tendency, especially with the strong shear environment inside the stator and rotor reactor. Therefore, a defoaming agent needs to be added to it to inhibit foaming and ensure good removal efficiency.

According to the yellow oil reduction method the present invention, preferably, the defoaming agent is one or more selected from polymeric alcohols (e.g. polyalkylene glycols, stearyl alcohols, etc.) and silicones (e.g. methyl silicone oil, etc.). The presence of a defoaming agent inhibits foaming of the amine solution in the strong shear environment of a stator-rotor reactor for acid gas removal or in a Higee reactor for oil scrubbing, and prevents the reduction of mixing and mass transfer efficiency.

According to the yellow oil reduction method the present invention, preferably, a volume ratio of the scrubbing oil to the rich amine solution is 1:10 to 20, preferably 1:2 to 5. Because of the good mixing effect of the Higee reactor, the ratio of scrubbing oil to amine solution is less than that of conventional oil scrubbing, which may reduce operating costs.

According to the yellow oil reduction method the present invention, preferably, the scrubbing oil is a cracked gasoline or a hydrogenated gasoline, preferably a hydrogenated gasoline.

According to the yellow oil reduction method the present invention, preferably, the ethylene cracking gas is originated from the fourth-stage compressor (five-stage compression process) or the third-stage compressor (four-stage compression process), preferably from the fourth-stage compressor (five-stage compression process).

According to the yellow oil reduction method the present invention, preferably, the ethylene cracking gas enters the reactor through a gas phase inlet of the stator-rotor reactor after heat exchange, and the temperature of the ethylene cracking gas increases after heat exchange but does not exceed 45° C. After the upstream steps such as compression and cooling, the temperature of the ethylene cracking gas varies within a certain range depending on the temperature and flow rate of the cooling water. In order to reduce condensation of heavy hydrocarbons in contact with the amine solution, the temperature of the ethylene cracking gas is raised by heat exchange to reduce the possibility of condensation of heavy hydrocarbons. However, when the temperature exceeds 45° C., the unsaturated hydrocarbons in the ethylene cracking gas tend to polymerize and form yellow oil.

The regenerative amine solution is cooled by heat exchange and then enters the reactor through a liquid phase inlet of the stator-rotor reactor, and the temperature difference between the temperature of the cooled ethylene cracking gas and the temperature of the ethylene cracking gas entering the stator-rotor reactor is ≤1° C. Reducing the temperature difference between the ethylene cracking gas and the amine solution prevents the condensation of heavy hydrocarbons and effectively reduces the generation of yellow oil.

According to the yellow oil reduction method the present invention, preferably, the rich amine solution separated from the separation unit enters the regeneration unit for regeneration after exchanging heat with the regenerated regenerative amine solution; the regenerated regenerative amine solution exchanges heat with the rich amine solution separated from the separation unit and the ethylene cracking gas in sequence, and the regenerative amine solution is then adjusted to a suitable temperature and enters the stator-rotor reactor for recycling.

In another aspect, the present invention provides an apparatus for yellow oil reduction in an acid gas removal unit for ethylene cracking gas for implementing the above method for yellow oil reduction, comprising: a stator-rotor reactor, a Higee reactor, a separation unit and a regeneration unit.

According to the apparatus for yellow oil reduction of the present invention, preferably, the structural form of the Higee reactor includes, but is not limited to, a stator-rotor reactor, a rotating packed bed, a rotating zigzag bed, and the like.

According to the apparatus for yellow oil reduction of the present invention, preferably, the separation unit is a buffer tank; and the regeneration unit is a regeneration tower.

The method for yellow oil reduction in an acid gas removal unit for ethylene cracking gas of the present invention reduces the condensation and dissolution of unsaturated hydrocarbons in an amine solution by controlling the reaction temperature and contact time, thereby reducing generation of yellow oil, and at the same time reduces the effect of yellow oil on the acid gas removal unit by utilizing the strong self-cleaning capability of the stator-rotor reactor. Compared with the prior art, the method for yellow oil reduction in an acid gas removal unit for ethylene cracking gas of the present invention reduces the generation of yellow oil, and at the same time is less prone to clogging of the reactor due to strong shear, which can enhance the stability of the acid gas removal unit for ethylene cracking gas.

The beneficial effects of the method for yellow oil reduction in an acid gas removal unit for ethylene cracking gas include:

(1) Compared with the existing acid gas removal unit for ethylene cracking gas, the method of the present invention greatly reduces the contact time of the gas-liquid two phases, inhibits the dissolution of butadiene and heavy diolefins in the amine solution, and thus can inhibit the generation of yellow oil at the source.

(2) The method of the present invention inhibits the adhesion and accumulation of yellow oil on the internal member through strong shear action, effectively prevents the clogging of the reactor by yellow oil, and thus achieves stable operation of the acid gas removal unit.

(3) Compared with the existing acid gas removal unit for ethylene cracking gas, the method of the present invention has a simple process, less equipment footprint and lower energy consumption.

In another aspect, the present invention provides a system for removing acid gas from ethylene cracking gas for implementing the above method for removing acid gas from ethylene cracking gas, comprising: a first-stage Higee reactor, a second-stage Higee reactor and a water scrubbing unit.

In the present invention, by utilizing Higee technology combined with compounded amine solution to strengthen the degree of acid gas removal from ethylene cracking gas during amine scrubbing process, the effect that the concentration of hydrogen sulfide and carbon dioxide in the ethylene cracking gas is ≤1 μL/L respectively after two-stage amine scrubbing is achieved.

The method for removing acid gas from ethylene cracking gas of the present invention has the following advantages:

Compared with the existing process for removing acid gas from ethylene cracking gas, the method of the present invention greatly improves the degree of acid gas removal during the amine scrubbing process, improves the utilization rate of the amine solution, and reduces the energy consumption required for regeneration. The method of the present invention eliminates the need for the alkali scrubbing process, realizes the source reduction of ethylene waste alkali solution, and reduces the three-waste emissions of the apparatus. The method of the present invention has a simple process, a small equipment footprint and low energy consumption.

### BRIEF DESCRIPTION OF THE DRAWINGS

FIG. 1 shows a schematic diagram of a system and process for removing acid gas from ethylene cracking gas in a preferred embodiment of the present invention.

FIG. 2 shows a schematic diagram of an apparatus and process for yellow oil reduction in an acid gas removal unit for ethylene cracking gas in a preferred embodiment of the present invention.

### DESCRIPTION OF THE REFERENCE SIGNS

1. First-stage Higee reactor;
2. Second-stage Higee reactor;
3. Water scrubbing unit;
4. Amine solution regeneration unit;
) 01. Stator-rotor reactor;
02. Higee reactor;
03. Separation unit;
04. Regeneration unit;
05. First heat exchanger;
06. Second heat exchanger.

### DETAILED DESCRIPTION OF THE INVENTION

In order to illustrate the present invention more clearly, the present invention is further described below in connection with preferred embodiments. It should be understood by those skilled in the art that what is specifically described below is illustrative rather than limiting and should not be used to limit the scope of the present invention.

All numerical designations of the present invention (e.g., temperature, time, concentration, weight, etc., including ranges of each) are generally approximate values that can be suitably varied (+) or (−) in increments of 0.1 or 1.0. All numerical designations are understood to be preceded by the term “about”.

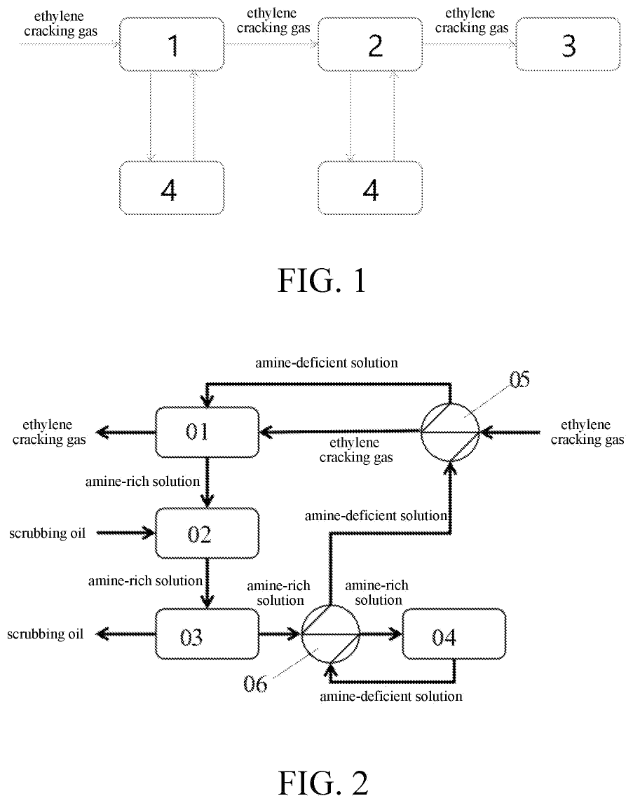

As shown in FIG. 1, the present invention provides herein a preferred embodiment of a system for removing acid gas from ethylene cracking gas, comprising a first-stage Higee reactor 1, a second-stage Higee reactor 2 and a water scrubbing unit 3. The first-stage Higee reactor 1 and the second-stage Higee reactor 2 are each equipped with an amine solution regeneration unit 4.

The ethylene cracking gas containing acid gas and the first-stage compounded amine solution enter the first-stage Higee reactor 1 through a gas phase inlet and a liquid phase inlet, respectively; the gas phase and the liquid phase are in intense contact inside the stator and rotor. After completion of acid gas removal, the gas phase and the liquid phase are respectively output from the first-stage Higee reactor 1 through the gas phase outlet and the liquid phase outlet. The gas phase is sent to the second-stage Higee reactor 2, and the liquid phase is regenerated by the amine regeneration unit 4 and recycled as the first-stage compounded amine solution.

The gas phase from the first-stage Higee reactor 1 and the second-stage compounded amine solution enter the second-stage Higee reactor 2 through a gas phase inlet and a liquid phase inlet, respectively. The gas phase and the liquid phase are in intense contact inside the stator and rotor to complete removal of the remaining acid gas. The gas phase and the liquid phase are respectively output from the second-stage Higee reactor 2 through gas phase outlet and liquid phase outlet. The gas phase is sent to a water scrubbing unit 3, and the liquid phase is regenerated by the amine regeneration unit 4 and recycled as the second-stage compounded amine solution.

### Example 1

In this example, the system process of FIG. 1 and compounded amine solutions were used to treat the following ethylene cracking gas containing acid gas. The pressure of the ethylene cracking gas containing acid gas was 1.0 MPa (G). Both the first- and second-stage compounded amine solutions were consisted of methyldiethanolamine (30%), N-tert-butyldiethanolamine (5%), diethanolamine (10%), ethanolamine (5%), and water, with a concentration of total amine of 50%. The rotation speed of both the first- and second-stage Higee reactors was 800 rpm, and the volume ratio of gas phase to liquid phase was 150:1.

The ethylene cracking gas containing acid gas and the first-stage compounded amine solution entered the reactor through the gas phase inlet and the liquid phase inlet of the first-stage Higee reactor, respectively. Under the shear crushing of the stator-rotor, the two phases underwent a vigorous mass transfer process to complete the acid gas removal in the ethylene cracking gas. After that, the ethylene cracking gas and the compounded amine solution left the reactor through the gas phase and liquid phase outlets of the first-stage Higee reactor, respectively. The first-stage compounded amine solution was sent to the amine solution regeneration unit 4 for regeneration, and the ethylene cracking gas entered the second-stage Higee reactor 2 for acid gas removal in contact with the second-stage compounded amine solution.

The ethylene cracking gas from the first-stage Higee reactor 1 and the second-stage compounded amine solution entered the second-stage Higee reactor 2 through a gas phase inlet and a liquid phase inlet, respectively. The gas phase and the liquid phase were in intense contact inside the stator and rotor to complete removal of the remaining acid gas. The gas phase and the liquid phase were respectively output from the second-stage Higee reactor 2 through the gas phase outlet and the liquid phase outlet. The gas phase was sent to the water scrubbing unit 3, and the liquid phase was regenerated by the amine solution regeneration unit 4 and recycled as the second-stage compounded amine solution.

The specific effects of ethylene cracking gas after passing through the two Higee reactors in sequence are shown in Table 1 below:

TABLE 1
Concentrations of hydrogen sulfide and
carbon dioxide in ethylene cracking gas

| First-stage Higee reactor | | Second-stage Higee reactor | |
|---|---|---|---|
| Inlet concentration | | Outlet concentration | |
| Hydrogen sulfide | Carbon dioxide | Hydrogen sulfide | Carbon dioxide |
| (μL/L) | (μL/L) | (μL/L) | (μL/L) |
| 1542 | 1513 | 0.0 | 0.6 |

### Example 2

In this example, the system process of FIG. 1 and compounded amine solutions were used to treat the following ethylene cracking gas containing acid gas. The pressure of the ethylene cracking gas containing acid gas was 2.03 MPa (G). Both the first- and second-stage compounded amine solutions were consisted of methyldiethanolamine (15%), N-tert-butyldiethanolamine (5%), N-tert-butylethanolamine (5%), diethylene glycolamine (5%) and water, with a concentration of total amine of 30%. The rotation speed of both the first- and second-stage Higee reactors was 600 rpm, and the volume ratio of gas phase to liquid phase was 250:1.

The ethylene cracking gas containing acid gas and the first-stage compounded amine solution entered the reactor through the gas phase inlet and the liquid phase inlet of the first-stage Higee reactor, respectively. Under the shear crushing of the stator-rotor, the two phases underwent a vigorous mass transfer process to complete the acid gas removal in the ethylene cracking gas. After that, the ethylene cracking gas and the compounded amine solution left the reactor through the gas phase and liquid phase outlets of the first-stage Higee reactor, respectively. The first-stage compounded amine solution was sent to the amine solution regeneration unit 4 for regeneration, and the ethylene cracking gas entered the second-stage Higee reactor 2 for acid gas removal in contact with the second-stage compounded amine solution.

The ethylene cracking gas from the first-stage Higee reactor 1 and the second-stage compounded amine solution entered the second-stage Higee reactor 2 through a gas phase inlet and a liquid phase inlet, respectively. The gas phase and the liquid phase were in intense contact inside the stator and rotor to complete removal of the remaining acid gas. The gas phase and the liquid phase were respectively output from the second-stage Higee reactor 2 through the gas phase outlet and the liquid phase outlet. The gas phase was sent to the water scrubbing unit 3, and the liquid phase was regenerated by the amine solution regeneration unit 4 and recycled as the second-stage compounded amine solution.

The specific effects of ethylene cracking gas after passing through the two Higee reactors in sequence are shown in Table 2 below:

TABLE 2
Concentrations of hydrogen sulfide and
carbon dioxide in ethylene cracking gas

| First-stage Higee reactor | | Second-stage Higee reactor | |
|---|---|---|---|
| Inlet concentration | | Outlet concentration | |
| Hydrogen sulfide | Carbon dioxide | Hydrogen sulfide | Carbon dioxide |
| (μL/L) | (μL/L) | (μL/L) | (μL/L) |
| 994 | 1024 | 0.0 | 0.3 |

### Example 3

In this example, the system process of FIG. 1 and compounded amine solutions were used to treat the following ethylene cracking gas containing acid gas. The pressure of the ethylene cracking gas containing acid gas was 1.55 MPa (G). Both the first- and second-stage compounded amine solutions were consisted of methyldiethanolamine (10%), methyl ethanolamine (4%), ethanolamine (1%) and water, with a concentration of total amine of 15%. The rotation speed of both the first- and second-stage Higee reactors was 1200 rpm, and the volume ratio of gas phase to liquid phase was 450:1.

The ethylene cracking gas containing acid gas and the first-stage compounded amine solution entered the reactor through the gas phase inlet and the liquid phase inlet of the first-stage Higee reactor, respectively. Under the shear crushing of the stator-rotor, the two phases underwent a vigorous mass transfer process to complete the acid gas removal in the ethylene cracking gas. After that, the ethylene cracking gas and the compounded amine solution left the reactor through the gas phase and liquid phase outlets of the first-stage Higee reactor, respectively. The first-stage compounded amine solution was sent to the amine solution regeneration unit 4 for regeneration, and the ethylene cracking gas entered the second-stage Higee reactor 2 for acid gas removal in contact with the second-stage compounded amine solution.

The ethylene cracking gas from the first-stage Higee reactor 1 and the second-stage compounded amine solution entered the second-stage Higee reactor 2 through a gas phase inlet and a liquid phase inlet, respectively. The gas phase and the liquid phase were in intense contact inside the stator and rotor to complete removal of the remaining acid gas. The gas phase and the liquid phase were respectively output from the second-stage Higee reactor 2 through the gas phase outlet and the liquid phase outlet. The gas phase was sent to the water scrubbing unit 3, and the liquid phase was regenerated by the amine solution regeneration unit 4 and recycled as the second-stage compounded amine solution.

The specific effects of ethylene cracking gas after passing through the two Higee reactors in sequence are shown in Table 3 below:

TABLE 3
Concentrations of hydrogen sulfide and
carbon dioxide in ethylene cracking gas

| First-stage Higee reactor | | Second-stage Higee reactor | |
|---|---|---|---|
| Inlet concentration | | Outlet concentration | |
| Hydrogen sulfide | Carbon dioxide | Hydrogen sulfide | Carbon dioxide |
| (μL/L) | (μL/L) | (μL/L) | (μL/L) |
| 534 | 255 | 0.0 | 0.0 |

As can be seen from the results shown in Tables 1 to 3, under the conditions described in the examples of the present invention, the combination of the Higee reactor and the compounded amine solutions can well satisfy the requirements for the removal of hydrogen sulfide and carbon dioxide from ethylene cracking gas.

### Example 4

In this example, a two-stage tandem Higee reactor serving as a hydrogen sulfide and carbon dioxide removal site, and a two-stage amine scrubbing or two-stage alkaline scrubbing using a compounded amine or alkaline solution as an absorbent, were used to treat the following ethylene cracking gas containing acid gas. The pressure of the ethylene cracking gas containing acid gas was 1.0 MPa (G). The rotation speed of the Higee reactors was all 1000 rpm and the volume ratio of the gas phase to the liquid phase was 200:1.

The ethylene cracking gas containing acid gas entered the reactor through the gas phase inlet of the Higee reactor and the absorbent entered the reactor through the liquid phase inlet of the Higee reactor. Under the shear crushing of the stator-rotor, the two phases underwent a vigorous mass transfer process to complete the acid gas removal in the ethylene cracking gas. After that, the ethylene cracking gas and the absorbent left the reactor through the gas phase and liquid phase outlets of the first-stage Higee reactor, respectively.

When the absorbent was a compounded amine solution, the compounded amine solution was consisted of methyldiethanolamine (6%), N-tert-butyldiethanolamine (1%), diethanolamine (2%), ethanolamine (1%) and water, with a concentration of total amine of 10%, and the compounded amine solution leaving the reactor was regenerated and recycled. When the absorbent was an alkali solution, the alkali solution was a sodium hydroxide solution with an alkali solution concentration of 10%. In order to ensure the concentration of free alkali in the alkali solution, it was necessary to discharge a certain mass of used alkali solution that had left the reactor and to replenish it with the same mass of fresh alkali solution.

The specific effects of the example are shown in Table 4 below. In the Table 4, the outlet limiting concentration was the concentration of cracking gas that must be reached at the outlet regardless of amine or alkali scrubbing:

TABLE 4
Compounded amine solution and alkali solution
effluents at the same removal degree

| | | Outlet limiting | | Volume of discharged waste | |
|---|---|---|---|---|---|
| Inlet concentration | | concentration | | liquid | |
| Hydrogen | Carbon | Hydrogen | Carbon | Compounded | Alkali |
| sulfide | dioxide | sulfide | dioxide | amine | solution |
| (μL/L) | (μL/L) | (μL/L) | (μL/L) | solution (g/h) | (g/h) |
| 500 | 500 | 0.0 | ≤1.0 | 0.0 | 72.0 |

From the results shown in Table 4, it can be seen that in order to achieve the outlet limit concentration shown in the table, when using the compounded amine solution as the absorbent, it is necessary to continuously regenerate and recycle the amine solution, because the regeneration is more thorough and there is no need to replace the compounded amine solution, and thus there is no waste liquid discharged. When using the alkali solution as the absorbent, as the acid gas and alkali solution continuously react to consume the active ingredient sodium hydroxide in the alkali solution, the effect of the alkali solution in removing acid gas is reduced. When the alkali solution cannot be regenerated, in order to meet the removal degree, the alkali solution needs to be replaced to maintain a certain concentration. During the replacement process, waste liquid will be discharged.

### Comparative Example 1

In this comparative example, the system process of FIG. 1 and a single amine solution were used to treat the following ethylene cracking gas containing acid gas. The pressure of the ethylene cracking gas containing acid gas was 1.0 MPa (G). The amine solution used in both the first-stage and second-stage were consisted of methyldiethanolamine at a concentration of total amine of 50%. The rotation speed of both the first- and second-stage Higee reactors was 800 rpm, and the volume ratio of gas phase to liquid phase was 150:1.

The ethylene cracking gas containing acid gas and the first-stage amine solution entered the reactor through the gas phase inlet and the liquid phase inlet of the first-stage Higee reactor, respectively. Under the shear crushing of the stator-rotor, the two phases underwent a vigorous mass transfer process to complete the acid gas removal in the ethylene cracking gas. After that, the ethylene cracking gas and the amine solution left the reactor through the gas phase and liquid phase outlets of the first-stage Higee reactor, respectively. The first-stage amine solution was sent to the amine solution regeneration unit 4 for regeneration, and the ethylene cracking gas entered the second-stage Higee reactor 2 for acid gas removal in contact with the second-stage compounded amine solution.

The ethylene cracking gas from the first-stage Higee reactor 1 and the second-stage amine solution entered the second-stage Higee reactor 2 through a gas phase inlet and a liquid phase inlet, respectively. The gas phase and the liquid phase were in intense contact inside the stator and rotor to complete removal of the remaining acid gas. The gas phase and the liquid phase were respectively output from the second-stage Higee reactor 2 through the gas phase outlet and the liquid phase outlet. The gas phase was sent to the water scrubbing unit 3, and the liquid phase was regenerated by the amine solution regeneration unit 4 and recycled as the second-stage amine solution.

The specific effects of ethylene cracking gas after passing through the two Higee reactors in sequence are shown in Table 5 below:

TABLE 5
Concentrations of hydrogen sulfide and
carbon dioxide in ethylene cracking gas

| First-stage Higee reactor | | Second-stage Higee reactor | |
|---|---|---|---|
| Inlet concentration | | Outlet concentration | |
| Hydrogen sulfide | Carbon dioxide | Hydrogen sulfide | Carbon dioxide |
| (μL/L) | (μL/L) | (μL/L) | (μL/L) |
| 1542 | 1513 | 162 | 447 |

As can be seen from the results shown in Table 5, the removal of hydrogen sulfide and carbon dioxide to less than 1 μL/L could not be achieved when using a single amine solution as an absorbent. By comparing with Example 1, it can be seen that the use of the compounded amine solution improved the mass transfer driving force of the acid gas and effectively enhanced the degree of removal of hydrogen sulfide and carbon dioxide.

### Comparative Example 2

In this comparative example, an amine scrubbing tower and a compounded amine solution were used to treat the following ethylene cracking gas containing acid gas. The pressure of the ethylene cracking gas containing acid gas was 1.0 MPa (G). The compounded amine solutions were consisted of methyldiethanolamine (30%), N-tert-butyldiethanolamine (5%), diethanolamine (10%), ethanolamine (5%), and water, at a concentration of total amine of 50%. The volume ratio of the gas phase to the liquid phase in the amine scrubbing tower was 150:1.

The ethylene cracking gas containing acid gas and the compounded amine solution entered the amine scrubbing tower through the gas phase inlet and the liquid phase inlet of the amine scrubbing tower, respectively, and the two phases complete the removal of acid gas from the ethylene cracking gas inside the packing. After that, the ethylene cracking gas and the compounded amine solution left the amine scrubbing tower through the gas phase and the liquid phase outlets of the amine scrubbing tower, respectively.

The specific effects of ethylene cracking gas after passing through the amine scrubbing tower are shown in Table 6 below:

TABLE 6
Concentrations of hydrogen sulfide and
carbon dioxide in ethylene cracking gas

| Inlet concentration | | Outlet concentration | |
|---|---|---|---|
| Hydrogen sulfide | Carbon dioxide | Hydrogen sulfide | Carbon dioxide |
| (μL/L) | (μL/L) | (μL/L) | (μL/L) |
| 1542 | 1513 | 323 | 741 |

As can be seen from the results shown in Table 6, the removal of hydrogen sulfide and carbon dioxide to less than 1 μL/L could not be achieved when using a conventional amine scrubbing tower. By comparing with Example 1, it can be seen that the use of the Higee reactor can effectively strengthen the mass transfer process between the gas-liquid two phases and enhance the degree of removal of hydrogen sulfide and carbon dioxide as compared to a conventional amine scrubbing tower.

### Comparative Example 3

In this comparative example, the system process of FIG. 1 and a compounded amine solution were used to treat the following ethylene cracking gas containing acid gas. The pressure of the ethylene cracking gas containing acid gas was 1.0 MPa (G). The compounded amine solution was consisted of methyldiethanolamine (30%), N-tert-butyldiethanolamine (5%), diethanolamine (10%), ethanolamine (5%), and water, at a concentration of total amine of 50%. The rotation speed of the Higee reactor was 800 rpm, and the volume ratio of gas phase to liquid phase was 150:1.

The ethylene cracking gas containing acid gas and the first-stage compounded amine solution entered the reactor through the gas phase inlet and the liquid phase inlet of the first-stage Higee reactor, respectively. Under the shear crushing of the stator-rotor, the two phases underwent a vigorous mass transfer process to complete the acid gas removal in the ethylene cracking gas. After that, the ethylene cracking gas and the compounded amine solution left the reactor through the gas phase and liquid phase outlets of the first-stage Higee reactor, respectively. The first-stage compounded amine solution was sent to the amine solution regeneration unit 4 for regeneration, and the ethylene cracking gas entered the second-stage Higee reactor 2 for acid gas removal in contact with the second-stage compounded amine solution.

The ethylene cracking gas from the first-stage Higee reactor 1 and the second-stage compounded amine solution entered the second-stage Higee reactor 2 through gas phase inlet and liquid phase inlet, respectively. The gas phase and the liquid phase were in intense contact inside the stator and rotor to complete removal of the remaining acid gas. The gas phase and the liquid phase were respectively output from the second-stage Higee reactor 2 through gas phase outlet and liquid phase outlet. The gas phase was sent to the water scrubbing unit 3, and the liquid phase was regenerated by amine solution regeneration unit 4 and recycled as the second-stage compounded amine solution.

The specific effects of ethylene cracking gas after passing through the two Higee reactors in sequence are shown in Table 7 below:

TABLE 7
Concentrations of hydrogen sulfide and
carbon dioxide in ethylene cracking gas

| First-stage Higee reactor | | Second-stage Higee reactor | |
|---|---|---|---|
| Inlet concentration | | Outlet concentration | |
| Hydrogen sulfide | Carbon dioxide | Hydrogen sulfide | Carbon dioxide |
| (μL/L) | (μL/L) | (μL/L) | (μL/L) |
| 2200 | 2047 | 0.6 | 247 |

As can be seen from the results shown in Table 7, in the case where the concentration of both hydrogen sulfide and carbon dioxide in the cracking gas exceeded 1500 μL/L, the use of the method provided by the present invention did not achieve the effect of removing the hydrogen sulfide and carbon dioxide to less than 1 μL/L. By comparing with Example 1, it can be seen that the method provided by the present invention cannot achieve the effect of removing hydrogen sulfide and carbon dioxide to less than 1 μL/L when the content of hydrogen sulfide and carbon dioxide in the ethylene cracking gas is too high. As can be seen from the examples and Comparative Examples, the method provided by the present invention can significantly remove acid gas from ethylene cracking gas to achieve a removal effect of hydrogen sulfide and carbon dioxide of ≤1 μL/L, respectively.

The present invention herein provides a preferred embodiment, as shown in FIG. 2. The apparatus for yellow oil reduction in an acid gas removal unit for ethylene cracking gas comprises a stator-rotor reactor 01, a Higee reactor 02, a separation unit 03 and a regeneration unit 04. Further, it may comprise a first heat exchanger 05 and a second heat exchanger 06.

After the ethylene cracking gas and the regenerative amine solution has been heat exchanged through the first heat exchanger 05, the ethylene cracking gas enters the reactor through the gas phase inlet of the stator-rotor reactor 01, the regenerative amine solution enters the reactor through the liquid phase inlet of the stator-rotor reactor 01, and the defoaming agent enters the reactor through an inlet arranged on the stator. The ethylene cracking gas, regenerative amine solution and defoaming agent are mixed inside the stator and rotor; the liquid phase is sheared and torn into tiny liquid filaments, droplets and films under the action of the two, which have a huge interphase mass-transfer specific surface area and a fast surface renewal rate, and thus can efficiently complete the removal of acid gas from the ethylene cracking gas. After completion of acid gas removal, the gas phase and liquid phase leave the reactor through gas phase outlet and liquid phase outlet of the stator-rotor reactor 01, respectively.

During the process of acid gas removal, hydrocarbons inevitably enter into the amine solution, and in order to avoid the dissolved hydrocarbons from generating yellow oil during thermal regeneration of the amine solution, the rich amine solution that enters the regeneration unit 04 is subjected to oil scrubbing in order to remove the dissolved hydrocarbons therefrom. The rich amine solution and scrubbing oil leaving from the stator-rotor reactor 01 enter the reactor for oil scrubbing through the liquid phase inlet of the Higee reactor 02. The rich amine solution and scrubbing oil are mixed inside the rotor, and the high-speed rotor crushes the two phases of oil and water into tiny droplets, which are continuously aggregated and dispersed to complete the mass transfer process of hydrocarbons from the aqueous phase to the oil phase. The hydrocarbons dissolved in the amine solution are extracted into the scrubbing oil, after which the rich amine solution and the scrubbing oil enter the separation unit 03 (preferably buffer tank) for separation; the scrubbing oil agglomerates into an oil phase and leaves from the upper part of the separation unit 03; the rich amine solution agglomerates into an aqueous phase and leaves from the lower part of the separation unit 03.

The separated rich amine solution enters the regeneration unit 04 (e.g., a regeneration tower) for regeneration after heat exchange with the regenerated regenerative amine solution to recover heat. The regenerated regenerative amine solution and the oil-washed rich amine solution are exchanged with the second heat exchanger 06 and with the ethylene cracking gas through the first heat exchanger 05, and then the regenerative amine solution is adjusted to an appropriate temperature and enters the stator-rotor reactor 01 for recycling.

The liquid phase is driven by the rotor and moves from the inside to the outside, and the residence time of the gas phase and the liquid phase in the chamber of the stator-rotor reactor 01 is ≤1s. Since the contact time is very short, it effectively inhibits the mass transfer process of hydrocarbons into the amine solution, which can reduce the dissolution of hydrocarbons and reduce the total amount of yellow oil generated from the source. The radial distance between the stator ring and the rotor ring of the stator-rotor reactor is 1 to 10 mm, preferably 1 to 5 mm; the linear velocity of the outermost rotor is 20 to 40 m/s, preferably 30 to 40 m/s. With a small distance between the stator ring and the rotor ring and a large relative velocity, a strong shear force is generated between the stator ring and the rotor ring, which prevents the generated yellow oil from being deposited on the reactor internal member; for the yellow oil that has already adhered to the internal member, the strong shear force forces it to come off. Therefore, it can greatly enhance the stability of the reactor and ensure the efficiency of acid gas removal.

### Example 5

In this example, the apparatus and process of FIG. 2 were used to remove acid gas from ethylene cracking gas and to reduce yellow oil, comprising the following process:

The ethylene cracking gas containing acid gas which had been warmed up to 40° C. by the first heat exchanger 05 and the regenerative amine solution (20 wt % MDEA solution) at 40° C. entered the stator-rotor through the gas phase and liquid phase inlets of the stator-rotor reactor 01, respectively. Methyl silicone oil entered the reactor through the additive inlet arranged on the stator. The gap between the adjacent stator ring and the rotor ring was 5 mm, and the linear velocity of the outermost rotor was 40 m/s. The gas phase and the liquid phase after completion of the acid gas removal left the reactor through the gas phase and liquid phase outlets of the stator-rotor reactor 01, respectively.

The rich amine solution leaving the stator-rotor reactor 01 with cracked gasoline entered the reactor for oil scrubbing through the liquid phase inlet of the Higee reactor 02. The volume ratio of cracked gasoline to rich amine solution was 1:10. The rich amine solution separated by the separation unit 03 (buffer tank) after oil scrubbing entered the regeneration unit 04 (regeneration tower) for regeneration, and the regenerative amine solution obtained after regeneration was cooled by heat exchange and then entered the stator-rotor reactor 01 for recycling.

After the system had stabilized, a sample was taken at the liquid phase outlet of the stator-rotor reactor, and the content of oil in the liquid phase was determined to be 136 mg/L. The stator-rotor reactor 01 was disassembled and no yellow oil was observed on the internal member.

### Example 6

In this example, the apparatus and process of FIG. 2 were used to remove acid gas from ethylene cracking gas and to reduce yellow oil, comprising the following process:

The ethylene cracking gas containing acid gas which had been warmed up to 38° C. by the first heat exchanger 05 and a regenerative amine solution (20 wt % MDEA solution) at 39° C. entered the stator-rotor through the gas phase and liquid phase inlets of the stator-rotor reactor 01, respectively. A higher alcohol defoaming agent entered the reactor through the additive inlet arranged on the stator. The gap between the adjacent stator ring and the rotor ring was 9 mm, and the linear velocity of the outermost rotor was 20 m/s. The gas phase and the liquid phase after completion of the acid gas removal left the reactor through the gas phase and liquid phase outlets of the stator-rotor reactor 01, respectively.

The rich amine solution leaving the stator-rotor reactor 01 with cracked gasoline entered the reactor for oil scrubbing through the liquid phase inlet of the Higee reactor 02. The volume ratio of cracked gasoline to rich amine solution was 1:20. The rich amine solution separated by separation unit 03 (a buffer tank) after oil scrubbing entered the regeneration unit 04 (a regeneration tower) for regeneration, and the regenerative amine solution obtained after regeneration was cooled by heat exchange and then entered the stator-rotor reactor 01 for recycling.

After the system had stabilized, a sample was taken at the liquid phase outlet of the stator-rotor reactor 01, and the content of oil in the liquid phase was determined to be 347 mg/L. The stator-rotor reactor 01 was disassembled and no yellow oil was observed on the internal member.

### Comparative Example 4

In this comparative example, ethylene cracking gas was subjected to the acid gas removal by the following process:

Ethylene cracking gas containing acid gas at 40° C. and a regenerative amine solution (20 wt % MDEA solution) at 35° C. entered the stator-rotor through the gas phase and liquid phase inlets of the stator-rotor reactor 01, respectively. Methyl silicone oil entered the reactor through the additive inlet arranged on the stator. The gap between the adjacent stator ring and the rotor ring was 5 mm, and the linear velocity of the outermost rotor was 40 m/s. The gas phase and the liquid phase after completion of the acid gas removal left the reactor through the gas phase and liquid phase outlets of the stator-rotor reactor 01, respectively.

The rich amine solution leaving the stator-rotor reactor 01 with cracked gasoline entered the reactor for oil scrubbing through the liquid phase inlet of the Higee reactor 02. The volume ratio of cracked gasoline to rich amine solution was 1:10. The rich amine solution separated by the separation unit 03 (a buffer tank) after oil scrubbing entered the regeneration unit 04 (a regeneration tower) for regeneration, and the regenerative amine solution obtained after regeneration was cooled by heat exchange and then entered the stator-rotor reactor 01 for recycling.

After the system had stabilized, a sample was taken at the liquid phase outlet of the stator-rotor reactor 01, and the content of oil in the liquid phase was determined to be 1320 mg/L. The stator-rotor reactor 01 was disassembled and no yellow oil was observed on the internal member.

As can be seen from the comparison between Example 5 and Comparative Example 4, when the temperature difference between the ethylene cracking gas and the regenerative amine solution entering the stator-rotor reactor 01 was too large, the heavy olefins in the ethylene cracking gas were prone to condensate and form yellow oil, resulting in an increase in the yellow oil content in the liquid phase. Therefore, the temperature of the gas and liquid phases entering the stator-rotor reactor should be controlled, in order to reduce the generation of yellow oil.

### Comparative Example 5

In this comparative example, ethylene cracking gas was subjected to the acid gas removal by the following process:

The ethylene cracking gas containing acid gas which had been warmed up to 40° C. by the first heat exchanger 05 and a regenerative amine solution (20 wt % MDEA solution) at 40° C. entered the stator-rotor through the gas phase and liquid phase inlets of the stator-rotor reactor 01, respectively. Methyl silicone oil entered the reactor through the additive inlet arranged on the stator. The gap between the adjacent stator ring and the rotor ring was 5 mm, and the linear velocity of the outermost rotor was 40 m/s. The gas phase and the liquid phase after completion of the acid gas removal left the reactor through the gas phase and liquid phase outlets of the stator-rotor reactor 01, respectively.

The rich amine solution leaving the stator-rotor reactor 01 entered the regeneration unit 04 (a regeneration tower) for regeneration, and the regenerative amine solution obtained after regeneration was cooled by heat exchange and then entered the stator-rotor reactor 01 for recycling.

After the system had stabilized, a sample was taken at the liquid phase outlet of the stator-rotor reactor 01, and the content of oil in the liquid phase was determined to be 2862 mg/L. The stator-rotor reactor 01 was disassembled and no yellow oil was observed on the internal member.

As can be seen from the comparison between Example 5 and Comparative Example 5, the rich amine solution without oil scrubbing contained a certain amount of butadiene and heavy diolefins. If it directly entered the regeneration unit for thermal regeneration, the high temperature of the regeneration process would promote the polymerization of unsaturated olefins, such as butadiene, to generate yellow oil, resulting in an increase in the yellow oil content in the liquid phase. Therefore, before entering the regeneration unit, the rich amine solution should be subjected to an oil scrubbing, in order to reduce the generation of yellow oil.

### Comparative Example 6

In this comparative example, the apparatus and process of FIG. 2 were used to remove acid gas from ethylene cracking gas and to reduce yellow oil, comprising the following process:

The ethylene cracking gas containing acid gas at 40° C. and a regenerative amine solution (20 wt % MDEA solution) at 40° C. entered the stator-rotor through the gas phase and liquid phase inlets of the stator-rotor reactor 01, respectively. Methyl silicone oil entered the reactor through the additive inlet arranged on the stator. The gap between the adjacent stator ring and the rotor ring was 20 mm, and the linear velocity of the outermost rotor was 40 m/s. The gas phase and the liquid phase after completion of the acid gas removal left the reactor through the gas phase and liquid phase outlets of the stator-rotor reactor 01, respectively.

The rich amine solution leaving the stator-rotor reactor 01 with cracked gasoline entered the reactor for oil scrubbing through the liquid phase inlet of the Higee reactor 02. The volume ratio of cracked gasoline to rich amine solution was 1:10. The rich amine solution separated by the separation unit 03 after oil scrubbing entered the regeneration unit 04 (a regeneration tower) for regeneration, and the regenerative amine solution obtained after regeneration was cooled by heat exchange and then entered the stator-rotor reactor 01 for recycling.

After the system had stabilized, a sample was taken at the liquid phase outlet of the stator-rotor reactor 01, and the content of oil in the liquid phase was determined to be 324 mg/L. The stator-rotor reactor 01 was disassembled and a small amount of yellow oil adhering to the internal member was observed.

As can be seen from the comparison between Example 5 and Comparative Example 6, when the gap between the adjacent stator ring and the rotor ring is too large, sufficient shear cannot be provided to prevent the generated yellow oil from adhering to the internal member.

### Comparative Example 7

In this comparative example, the apparatus and process of FIG. 2 were used to remove acid gas from ethylene cracking gas and to reduce yellow oil, comprising the following process:

The ethylene cracking gas containing acid gas at 40° C. and a regenerative amine solution (20 wt % MDEA solution) at 40° C. entered the stator-rotor through the gas phase and liquid phase inlets of the stator-rotor reactor 01, respectively. Methyl silicone oil entered the reactor through the additive inlet arranged on the stator. The gap between the adjacent stator ring and the rotor ring was 5 mm, and the linear velocity of the outermost rotor was 10 m/s. The gas phase and the liquid phase after completion of the acid gas removal left the reactor through the gas phase and liquid phase outlets of the stator-rotor reactor 01, respectively.

The rich amine solution leaving the stator-rotor reactor 01 with cracked gasoline entered the reactor for oil scrubbing through the liquid phase inlet of the Higee reactor 02. The volume ratio of cracked gasoline to rich amine solution was 1:10. The rich amine solution separated by the separation unit 03 (a buffer tank) after oil scrubbing entered the regeneration unit 04 (a regeneration tower) for regeneration, and the regenerative amine solution obtained after regeneration was cooled by heat exchange and then entered the stator-rotor reactor 01 for recycling.

After the system had stabilized, a sample was taken at the liquid phase outlet of the stator-rotor reactor 01, and the content of oil in the liquid phase was determined to be 467 mg/L. The stator-rotor reactor 01 was disassembled and a small amount of yellow oil adhering to the internal member was observed.

As can be seen from the comparison between Example 5 and Comparative Example 7, a low linear speed of the outermost rotor meant that the rotor speed was low, and the low speed did not provide enough shear to prevent the generated yellow oil from adhering to the internal member. At the same time, the low speed increased the residence time of the liquid in the reactor and increased the dissolution of hydrocarbons in the liquid phase.

### Comparative Example 8

In this comparative example, an amine scrubbing tower was used to remove acid gas from ethylene cracking gas, comprising the following process:

The ethylene cracking gas containing acid gas at 40° C. and a regenerative amine solution (20 wt % MDEA solution) at 40° C. entered the amine scrubbing tower through the gas phase and liquid phase inlets of the amine scrubbing tower, respectively. Methyl silicone oil entered the amine scrubbing tower by mixing with the amine solution in advance, and left the amine scrubbing tower through the gas phase and liquid phase outlets, respectively, after completion of the acid gas removal.

The rich amine solution leaving the amine scrubbing tower with cracked gasoline entered the reactor for oil scrubbing through the liquid phase inlet of the Higee reactor 02. The volume ratio of cracked gasoline to rich amine solution was 1:10. The rich amine solution separated by the separation unit 03 (buffer tank) after oil scrubbing entered the regeneration unit 04 (regeneration tower) for regeneration, and the regenerative amine solution obtained after regeneration was cooled by heat exchange and then entered the amine scrubbing tower for recycling.

After the system had stabilized, a sample was taken at the liquid phase outlet of the stator-rotor reactor, and the content of oil in the liquid phase was determined to be 969 mg/L. The amine scrubbing tower was disassembled and a large amount of yellow oil adhering to the internal member was observed.

As can be seen from the comparison between Example 5 and Comparative Example 8, when an amine scrubbing tower was used as a place to remove acid gas, a large amount of unsaturated hydrocarbons was dissolved in the amine solution due to the long residence time in the tower. Even if an oil scrubbing process was used before the regeneration unit, the unsaturated hydrocarbons dissolved in the amine solution cannot be completely eluted, resulting in a large amount of yellow oil being generated in the regeneration unit. Some of the yellow oil generated went into the amine scrubbing tower with the lean solution. Due to the weak self-cleaning ability of the amine scrubbing tower, the yellow oil brought by the regenerative amine solution was enriched on the plate or packing and clogs the amine scrubbing tower.

As can be seen from the Examples and Comparative Examples, the method for yellow oil reduction in an acid gas removal unit for ethylene cracking gas provided by the present invention reduces the generation of yellow oil in the acid gas removal unit while inhibiting the yellow oil from adhering to the internal member within the acid gas removal unit. Obviously, the foregoing Examples of the present invention are merely examples for the purpose of clearly illustrating the present invention and are not intended to be a limitation of the embodiments of the present invention. For those of ordinary skill in the art, other changes or modifications in different forms can be made on the basis of the above description. It is impossible to exhaustively enumerate all the embodiments here, and all obvious changes or modifications derived from the technical solutions of the present invention are still within the protection scope of the present invention.

1. A method for removing acid gas from ethylene cracking gas, comprising:
subjecting ethylene cracking gas containing acid gas to a first-stage Higee amine scrubbing, a second-stage Higee amine scrubbing and a water scrubbing in sequence;
wherein a first-stage compounded amine solution is used in the first-stage Higee amine scrubbing, and a second-stage compounded amine solution is used in the second-stage Higee amine scrubbing;
the first-stage compounded amine solution and second-stage compounded amine solution independently comprise two or more of triethanolamine, methyldiethanolamine, N-tert-butyl diethanolamine, N-methyl-tert-butylaminoethyloxyethanol, tert-butylaminohexyloxyhexanol, tert-butylaminoethanol, diethanolamine, diglycolamine, methyloethanolamine, N-tert-butylethanolamine and ethanolamine;
wherein at least one tertiary amine is included.

2. The method for removing acid gas from ethylene cracking gas according to claim 1, wherein each of the first-stage compounded amine solution and the second-stage compounded amine solution are regenerated and recycled after absorption of the acid gas.

3. The method for removing acid gas from ethylene cracking gas according to claim 1, wherein the first-stage compounded amine solution comprises at least one tertiary amine, one secondary amine and one primary amine; and/or, the second-stage compounded amine solution comprises at least one tertiary amine, one secondary amine and one primary amine.

4. (canceled)

5. The method for removing acid gas from ethylene cracking gas according to claim 3, wherein in the first-stage compounded amine solution, the molar ratio of the tertiary amine to secondary amine is 0.1-10:1, and the molar ratio of the secondary amine to primary amine is 0.5-10:1; and/or, in the second-stage compounded amine solution, the molar ratio of the tertiary amine to secondary amine is 0.1-10:1, and the molar ratio of the secondary amine to primary amine is 0.5-10:1.

6. (canceled)

7. The method for removing acid gas from ethylene cracking gas according to claim 1, wherein the concentration of total amine in each of the first-stage compounded amine solution and/or second-stage compounded amine solution is 5% to 80%.

8. The method for removing acid gas from ethylene cracking gas according to claim 1, wherein the first-stage and the second-stage Higee amine scrubbing comprise the following specific processes:
inputting the ethylene cracking gas containing acid gas and the first-stage compounded amine solution to a first-stage Higee reactor through a gas phase inlet and a liquid phase inlet, respectively; after the removal of acid gas by intense contact between the gas phase and the liquid phase inside the stator and rotor, outputting the gas phase and the liquid phase from the gas phase outlet and the liquid phase outlet of the first-stage Higee reactor, respectively, at which the gas phase is sent to the second-stage Higee reactor, and the liquid phase is regenerated and recycled as the first-stage compounded amine solution;
inputting the gas phase from the first-stage Higee reactor and the second-stage compounded amine solution to the second-stage Higee reactor through a gas phase inlet and a liquid phase inlet, respectively; after the removal of the remaining acid gas by intense contact between the gas phase and the liquid phase inside the stator and rotor, outputting the gas phase and the liquid phase from the gas phase outlet and the liquid phase outlet of the second-stage Higee reactor, respectively, at which the gas phase is sent to a water scrubbing unit, and the liquid phase is regenerated and recycled as the second-stage compounded amine solution.

9. The method for removing acid gas from ethylene cracking gas according to claim 8, wherein the first-stage Higee reactor and/or the second-stage Higee reactor has a rotational speed of 100 rpm to 1400 rpm; and/or, the volume ratio of the gas phase to the liquid phase in the first-stage Higee reactor and/or second-stage Higee reactor is 100 to 500:1; and the gas phase pressure is 0.5 to 2.5 MPa (G).

10. (canceled)

11. The method for removing acid gas from ethylene cracking gas according to claim 1, wherein the ethylene cracking gas containing acid gas is derived from a three- or four-stage compressor, wherein the content of hydrogen sulfide is ≤1500 μL/L and the content of carbon dioxide is ≤1500 μL/L.

12. (canceled)

13. The method for removing acid gas from ethylene cracking gas according to claim 1, wherein the contents of hydrogen sulfide and carbon dioxide in the ethylene cracking gas after the second-stage Higee amine scrubbing are 1 μL/L or less, respectively.

14. The method for removing acid gas from ethylene cracking gas according to claim 1, wherein a method for yellow oil reduction in an acid gas removal unit for ethylene cracking gas is used to implement the first-stage Higee amine scrubbing and/or the second-stage Higee amine scrubbing, comprising:
inputting an ethylene cracking gas, a regenerative amine solution and a defoaming agent to a stator-rotor reactor, and the gas phase and the liquid phase leaving the stator-rotor reactor respectively after removal of acid gas by countercurrent contact between the gas phase and the liquid phase inside the stator and rotor;
inputting the liquid phase left the stator-rotor reactor, named rich amine solution, and a scrubbing oil to a Higee reactor for oil scrubbing, after which the rich amine solution and scrubbing oil enter a separation unit for separation;
regenerating the separated rich amine solution into a regenerative amine solution, which enters the stator-rotor reactor for recycling.

15. The method for removing acid gas from ethylene cracking gas according to claim 14, wherein the residence time of the ethylene cracking gas, the regenerative amine solution and the defoaming agent in the stator-rotor reactor is ≤1 s; and/or, the radial distance between the stator ring and the rotor ring of the stator-rotor reactor is 1 mm to 10 mm; and the linear velocity of the outermost rotor is 20 m/s to 40 m/s.

16.-17. (canceled)

18. The method for removing acid gas from ethylene cracking gas according to claim 14, wherein the defoaming agent enters the reactor through an additive inlet arranged on the stator of the stator-rotor reactor.

19. The method for removing acid gas from ethylene cracking gas according to claim 14, wherein the defoaming agent is one or more selected from polymeric alcohols and silicones.

20. The method for removing acid gas from ethylene cracking gas according to claim 14, wherein the volume ratio of the scrubbing oil to the rich amine solution is 1:10 to 20; and/or, the scrubbing oil is a cracked gasoline or a hydrogenated gasoline.

21. (canceled)

22. The method for removing acid gas from ethylene cracking gas according to claim 14, wherein the ethylene cracking gas enters the reactor through a gas phase inlet of the stator-rotor reactor after heat exchange, and the temperature of the ethylene cracking gas increases after heat exchange but does not exceed 45° C.; and
the regenerative amine solution is cooled by heat exchange and then enters the reactor through a liquid phase inlet of the stator-rotor reactor, and the temperature difference between the temperature of the cooled ethylene cracking gas and the temperature of the ethylene cracking gas entering the stator-rotor reactor is ≤1° C.

23. The method for removing acid gas from ethylene cracking gas according to claim 14, wherein the rich amine solution separated from the separation unit enters the regeneration unit for regeneration after exchanging heat with the regenerative amine solution; the regenerative amine solution exchanges heat with the rich amine solution separated from the separation unit and the ethylene cracking gas in sequence, and the regenerative amine solution is then adjusted to a suitable temperature and enters the stator-rotor reactor for recycling.

24. The method for removing acid gas from ethylene cracking gas according to claim 14, wherein an apparatus for yellow oil reduction in an acid gas removal unit for ethylene cracking gas is used to implement the method for yellow oil reduction, comprising: a stator-rotor reactor, a Higee reactor, a separation unit and a regeneration unit.

25. The method for removing acid gas from ethylene cracking gas according to claim 24, wherein the Higee reactor is in the form of a stator-rotor reactor, a rotating packed bed or a rotating zigzag bed.

26. The method for removing acid gas from ethylene cracking gas according to claim 24, wherein the separation unit is a buffer tank; and the regeneration unit is a regeneration tower.

27. A system for removing acid gas from ethylene cracking gas, wherein the system is used to implement the method according to claim 1, comprising: a first-stage Higee reactor, a second-stage Higee reactor and a water scrubbing unit.
